(19) United States
(12) Patent Application Publication
(10) Pub. No.: US 2023/0308608 A1
(43) Pub. Date: Sep. 28, 2023

(54) Automated Moderation Methods for Virtual Venues

(71) Applicant: Lawrence Au, Vienna, VA (US)

(72) Inventor: Lawrence Au, Vienna, VA (US)

(21) Appl. No.: 18/144,169

(22) Filed: May 6, 2023

Related U.S. Application Data
(63) Continuation-in-part of application No. 17/467,433, filed on Sep. 6, 2021, now Pat. No. 11,683,443.

(51) Int. Cl. H04N 7/15; G06F 3/16; G06F 3/0486; G06F 3/04845; G06F 3/04817

(52) U.S. Cl. CPC H04N 7/157; G06F 3/165; G06F 3/0486; G06F 3/04845; G06F 3/04817

(57) ABSTRACT

Beyond prior art simulating traditional powers such as moderators and breakout rooms, the present invention considers an approach where each participant is their own personal breakout room, over which they have sole and ultimate control. Building upon the super power a first participant has over their own personal breakout room, the question of whether a second participant entered of their own accord, or was invited in by the first participant can subsequently control whether the second participant can be ‘ejected’ (in the former case) or simply made to ‘leave’ (in the second case). The responsibility a second participant carries by entering into a private conversation (also referred to herein as ‘convo’) with a first participant thus includes a risk that if the first participant dislikes them, can result in ‘ejection’ of the second participant, which in the present invention carries consequences.

This application repeats a substantial portion of prior application Ser. No. 17/467,433, filed 6 Sep. 2021, and adds and claims additional disclosure not presented in the prior application. Since this application names an inventor or inventors named in the prior application, it may constitute a continuation-in-part of the prior application. Should applicant desire to obtain the benefit of the filing date of the prior application, attention is directed to 35 U.S.C. 120 and 37 CFR 1.78.

### BACKGROUND OF THE INVENTION

In prior art, videoconferencing platforms have great difficulty competing with the scale of large performances spaces and convention center meeting halls, because chaos from having many strangers packed together is intensified by the more limited communication bandwidth of virtual spaces.

With more chaos comes more conflicts between participants, and with more conflicts, a greater need for moderation to control conflicts. Moderation in virtual spaces is harder because the greater anonymity of virtual participants encourages them to misbehave. In most cases they can just vanish without consequences: in virtual spaces there are no physical bouncers to punish misbehaving people by heaving them out of a venue. Instead, virtual hosts have to hire moderators to watch every interaction, trying to catch people who are ruining the enjoyment of participants and when they find them, can only isolate or remove them from the virtual venue.

Prior art virtual spaces often use breakout rooms to reduce the chaos, but for participants, choosing to leave and to enter breakout rooms is more cumbersome than physical spaces, where one can have conversations while looking over one's shoulder at people one would rather be talking to. Host moderation of who can and cannot enter breakout rooms is also cumbersome. So between the extra cost of watching every participant interaction, and the cost of that monitoring in every breakout room, virtual spaces are at a real cost disadvantage to physical venues. And, for participants trying to enjoy these virtual events, those with social privileges often take advantage of those with less social privileges, because of the anonymity that virtual spaces confer. For instance, it's common for men to pick on women.

Although moderators may catch some of the most egregious of transgressions in virtual spaces, the inherent flaws of prior art videoconferencing has prevented them from competing with physical venues at a crowd size above 500, despite the lower cost of renting a virtual venue.

However, prior art moderation tools, breakout rooms and security codes are all limited to processes we′d expect in physical space: bouncers and security guards, physical breakout rooms with walls, and the granting and revoking of security codes. Although familiar, these traditional processes are not necessarily optimal, since virtual spaces offer computable moderation opportunities which are powerful beyond traditional physical moderation processes.

In general, it could be more optimal to design moderation processes around the needs of participants, rather than slavishly emulating traditional physical space moderation processes, while taking advantage of computable opportunities to grant participants “super powers” in virtual space to moderate that space, provided that interactions between participants using their super powers naturally converge toward a better experience for most participants.

Already in prior art versions of meta-verse venues, participants have been granted powers to vote on expelling other participants from breakout or meeting rooms, and individual participants have been granted powers to break off unwanted contact, via specific gestures, much like BDSM safe words. Although these new powers can reduce unwanted interactions, they fall short of imposing the kind of consequences on misbehavior that would enable virtual spaces to compete with large 500 participant physical venues.

In large 500+ participant physical venues, small transgressions are met with small consequences, such as person who is offended moving away from you, and slightly larger transgression are met with slightly larger consequences such as yelling at a person or asking an usher to be be re-seated away from a person. And when one person has been the subject of more than one complaint, that person may be offered a choice of behaving better or forfeiting either their current seat or even have to leave the event. There could be a way to also connect the minor meta-verse “super power” of breaking off contact to larger consequences in virtual events, and this can be a way virtual events can compete with large physical venues on a cost basis which is inclusive of moderations costs, for the same overall participant satisfaction.

### SUMMARY OF THE INVENTION

The present invention takes a unique approach to satisfying needs of virtual space participants. Rather than simulating traditional powers such as moderators and breakout rooms, the present invention considers an approach where each participant is their own personal breakout room, over which they have sole and ultimate control. Building upon the super power a first participant has over their own personal breakout room, the question of whether a second participant entered of their own accord, or was invited in by the first participant can subsequently control whether the second participant can be ‘ejected’ (in the former case) or simply made to ‘leave’ (in the second case). The responsibility a second participant carries by entering into a private conversation (also referred to herein as ‘convo’) with a first participant thus includes a risk that if the first participant dislikes them, can result in ‘ejection’ of the second participant, which in the present invention carries consequences. The mildest consequence is that an ‘ejection’ indicator marks the second participant, plus a ‘stalker blocker’ which bounces them away from the first participant should they attempt to reconvene. A greater consequence occurs if they collect multiple ‘ejection’ indicators, which marks them to others as undesirable. For participants with egregiously large multiple ‘ejection’ counts, the present invention automatically escalates consequences to actual penalties, such as forfeiture of deposit money or forfeiture of participation rights.

These subtle levels of consequences inform users, on both conscious and subconscious levels, to shape how they behave with other participants personal breakout rooms. If they are invited into a private conversation, they might take a few more risks in expressing themselves, knowing that they only risk being made to leave. If on the other hand, they barged into someone's private conversation, knowing they could be ejected induces them to be more polite and inoffensive, because they are at greater risk for either public shaming from being ejected, or penalties from multiple ejections.

By computing the distinction between being invited into a room and barging in, the present invention automatically infers at each convo termination whether a problem has emerged, and rather than hiding such problems, makes them more visible so the greater community of participants can more easily handle them. During the process of talking about related issues in subsequent conversations, more evidence of problems may emerge, which then automatically lead to penalties to discourage people from misbehaving.

AirBnb has successfully used crowdsourced reviews to discourage people from misbehaving, on both the guest and host sides of contracts. The present invention crowdsources convo termination evidence to discourage people from misbehaving in conversations, on both sides of conversations, to greatly reducing the cost of moderating large venues and enable virtual venues to compete with large physical venues. As a result, participants can mingle with untrustworthy strangers, assured that interactions will remain within acceptable bounds they each choose, and that their super power to eject people means no host moderator can infringe on this freedom.

### BRIEF DESCRIPTION OF THE DRAWINGS

FIG. 1 shows an example of a Large Scale Videoconferencing Event.

FIG. 2 shows examples of Large Scale Videoconferencing Event Viewing Options.

FIG. 3 shows Search Options for searching for participants.

FIG. 4 shows an example of using a “those who like me” search option.

FIG. 5 shows dragging to overlap Avatars for private conversation.

FIG. 6 shows dragging to end a private conversation (convo).

FIG. 7 shows an absence of a private conversation after ending it.

FIG. 8 shows dragging to reconvene a private conversation.

FIG. 9 shows dragging to eject a participant from a private conversation.

FIG. 10 shows the ‘Stalker Blocker” bouncing an ejected participant away.

FIG. 11 shows dispersing unwanted mobbing of a participant in private conversation.

FIG. 12 shows ejection line indicators after mass ejection of a mob.

FIG. 13 shows tracking of ejected participants after ejection.

FIG. 14 shows selecting a subset of participants in a convo, for one-way private conversation.

FIG. 15 shows dragging to upgrade a one-way to a two-way private conversation, and a ‘Stalker Blocker’ bouncing away a mass-ejected participant.

FIG. 16 shows excess ejection indicators for a single participant, causing them penalties for excess ejections.

FIG. 17 shows cancellation of ejection and its risk of associated penalties.

FIG. 18 shows expansion of a personal conversation area beyond default avatar size icons.

FIG. 19 shows further expansion of a personal conversation area using a corner grow box.

FIG. 20 shows expansion of a personal conversation area to the size of a breakout room.

FIG. 21 shows a conversation initiation method for putting participants in a private conversation.

FIG. 22 shows a conversation joining method for adding participants to an existing private conversation.

FIG. 23 shows a conversation joining methods for adding participants to part of an existing private conversation.

FIG. 24 shows a conversation ending method which may cause an ejection indication for a participant.

FIG. 25 shows an ejection cancellation method where a participant cancels an ejection and its associated possible penalties.

FIG. 26 shows a mass ejection method for ejecting a subset of participants from a conversation, chosen because they initiated their entry to the conversation.

FIG. 27 shows a focused ejection method for ejecting a limited subset of participants from a conversation, who were not in the subset of participants dragged back and forth.

FIG. 28 shows an ejection tracking method for showing behaviors of ejection participants.

FIG. 29 shows an ejection penalty method for charging or warning participants about their ejections.

FIG. 30 shows an avatar enlargement method for transitioning from a default avatar size to a breakout room size area.

FIG. 31 shows an avatar shrinking method for transition from a breakout room size area to a default avatar size.

FIG. 32 shows avatar lip-reading privacy option icons and their privacy effects.

FIG. 33 shows a method for enabling and disabling avatar lip-reading privacy options.

FIG. 34 shows a conversation moderation method utilizing methods of FIGS. 21, 22, 23, 24, 26, 27, 28, 29 and 33.

FIG. 35 shows a system and method of Computer Enabled Videoconferencing for Improved Person-to-person Interactions.

FIG. 36 shows a method of modeling crowd acoustics in a packed virtual venue.

FIG. 37 shows a method of computing search results for liked avatar tiles.

FIG. 38 shows an example of search or scan results showing participant interactions.

FIG. 39 shows an example of search or scan results showing ejected participant interactions.

### DESCRIPTION OF THE INVENTION

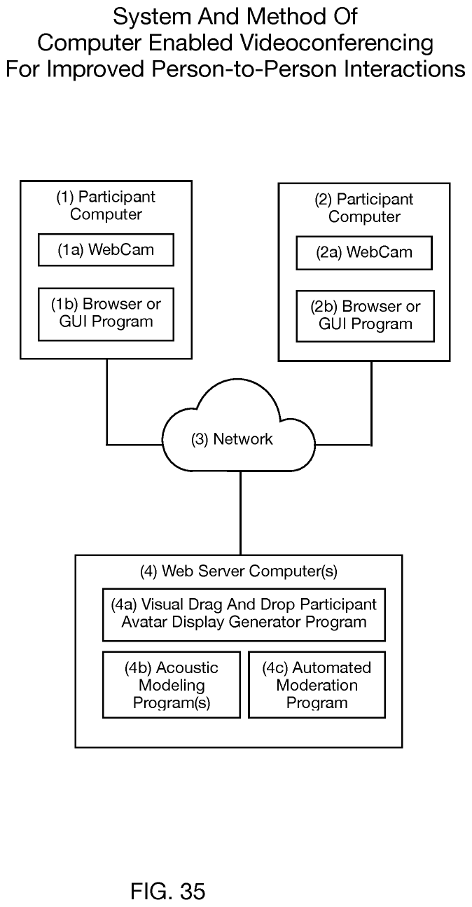

FIG. 35 shows some of the computer hardware which may support the present invention, with lines showing how they communicate over a network, such as the Internet. Thus (1) Participant computer and (2) Participant computers are usually equipped with a WebCam and a Web browser or other computer program which sends video feeds over the Network (3) to a Web Server Computer(s) which for greater bandwidth is often a bank of clustered computers. In the Web Server Computer(s) are programs to serve elements of the Visual Drag and Drop Participant Avatar Display Generating Program (4a), so participants can hear and see each other, as well as choose new locations in the video conferencing venue. Additional programs running in the Web Server computer(s) (4) may include Automated Moderation Programs (4c) which automatically bounce back ejected participants from re-entering private conversations, or automatically eject participants from private conversations in a participants personal meeting space, when participants use their ‘super power’ to eject others from their personal meeting space, or to automatically apply penalties for excess or egregiously many ejections.

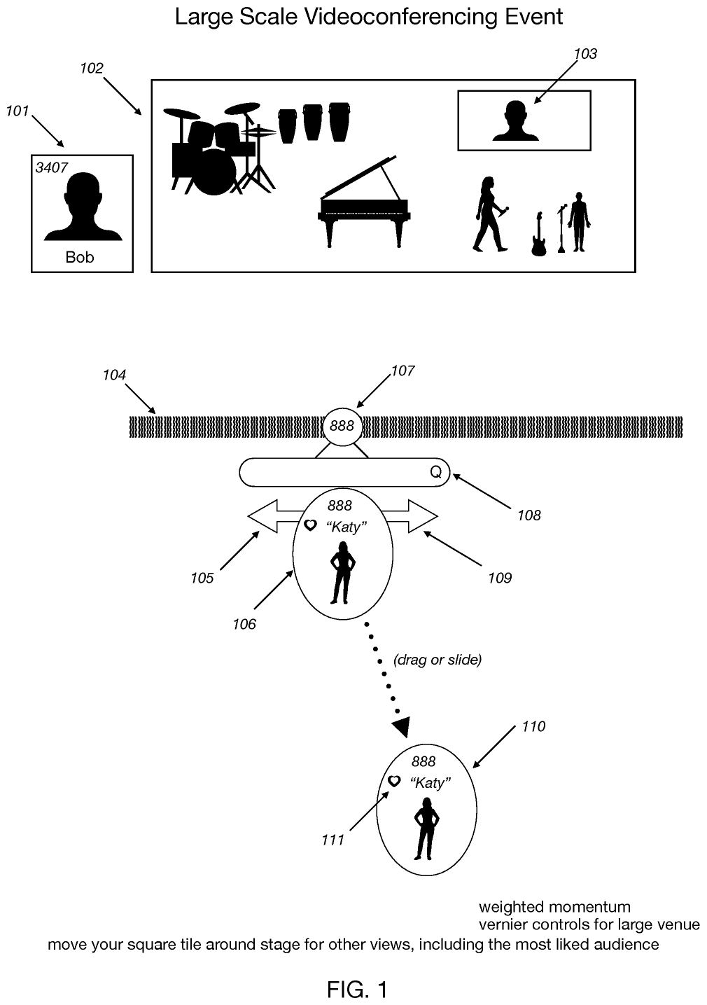

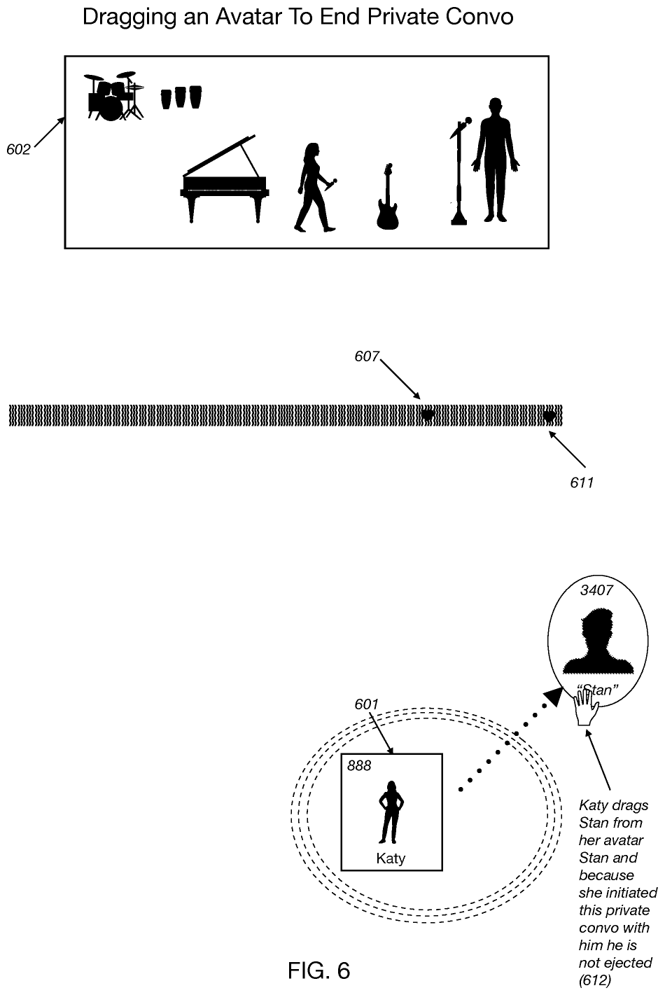

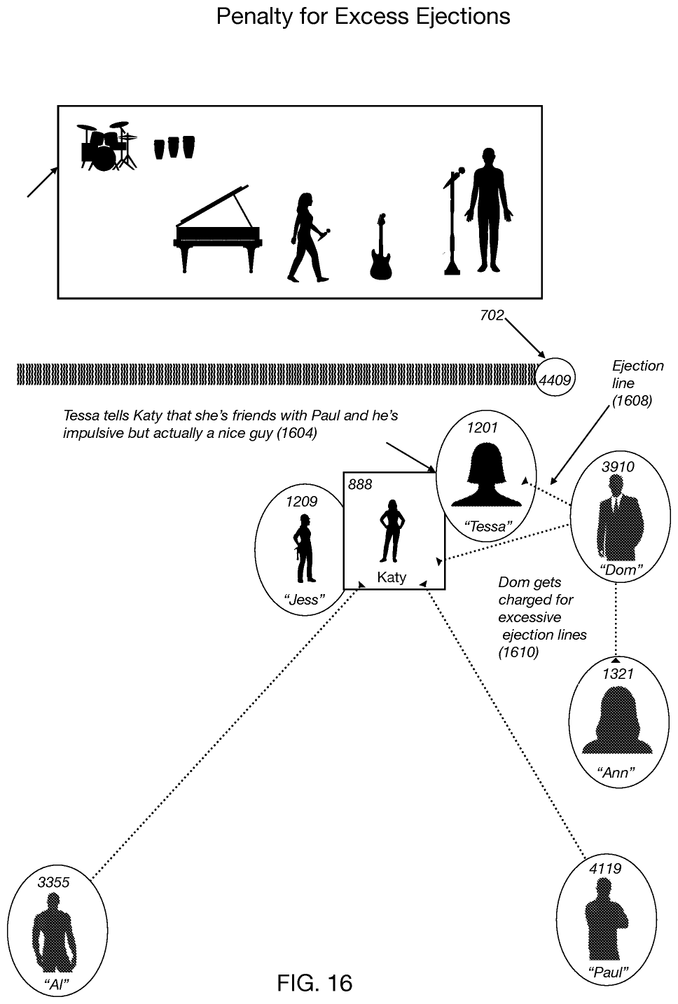

FIG. 1 through 20 show examples of user interfaces generated by Automated Moderation Programs (4c). FIG. 1 through 3 show general features of these user interfaces, where a window showing a video feed from a stage or performance space is at the top of the user interface. The auditory feed from the event is from the stage or performance space, so participants cannot hear each other unless they are in private conversations they themselves value.

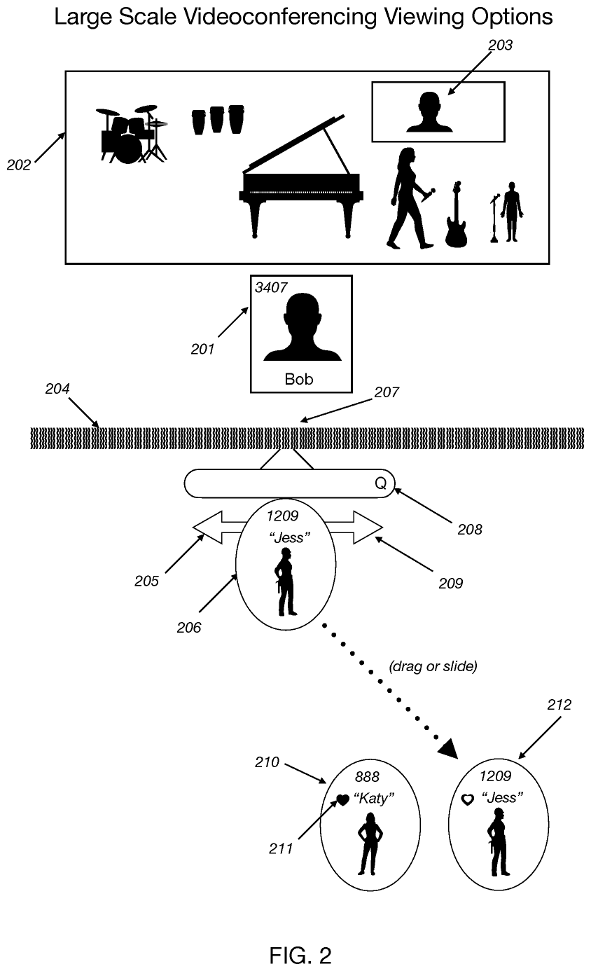

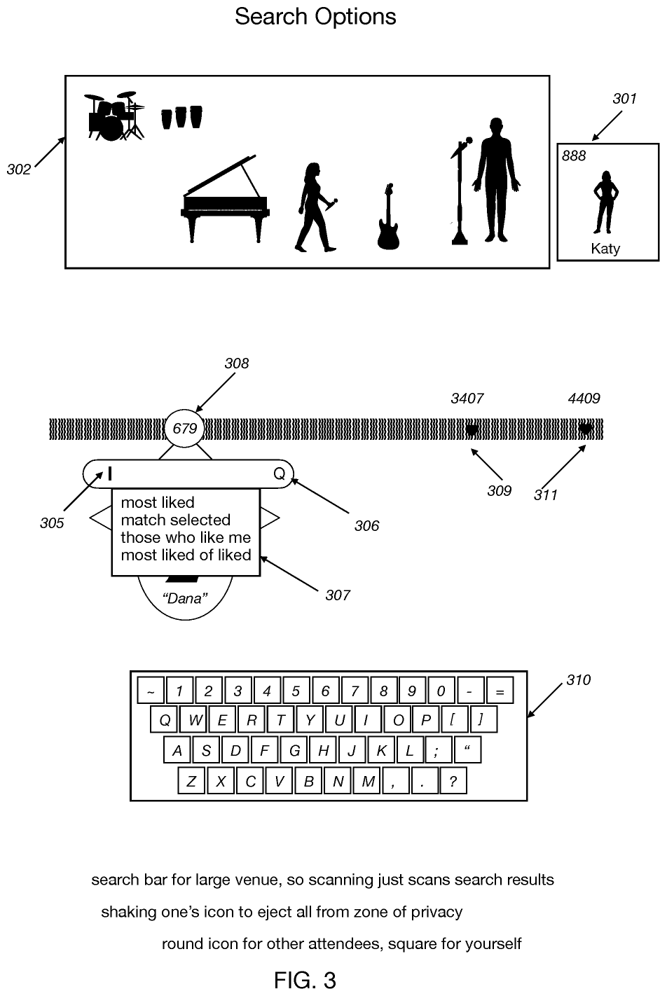

FIG. 1 shows an example of a participant-oriented user interface to a large scale videoconferencing event. At the top is a view of a stage, chosen by a participant Bob (101). Since Bob has chosen to place his avatar tile to the left of the stage view, he sees the drums up close, but the piano at mid-stage farther away, and the vocalists farthest away. In FIG. 2, Bob (201) has moved his avatar to mid-stage, and now sees the piano closest. In FIG. 3, Katy (301) has placed her avatar tile to the right of the stage and sees the vocalists closest. The present invention thus allows participants to customize their view of the event, unlike prior art which fills the entire user view with other participants avatars video feeds. In this description of the present invention, participant tiles, avatars and video feeds interchangeably refer to the way that live video of participants are presented to other participants.

Below the stage, FIG. 1 also shows a long strip of highly compressed participant tiles (104) packing hundreds to thousands or even tens of thousands of participants into a single scrubbable strip. It isn't possible to have meaningful participant live video showing thousands of participant squares if each are too small to clearly distinguish. So access to them is compressed to the strip (104) where they can be quickly scanned and searched, then viewed a few at a time at distinguishable visual sizes. For this example of a user interface, the seat numbers assigned to participants correspond to the left to right order where they pop up in the strip, with the lower seat numbers on the left and the higher seat numbers on the right.

By dragging the slider (107) along the strip, or inching it along the strip by pressing the left arrow (105) or right arrow (109), Bob has selected participant number 888 “Katy”. Having seen what she looks like, he drags her popup tile away from the strip, to park a copy of her (110) on his view. He can press the ‘heart’ icon on her avatar to signal to her that he likes her.

In FIG. 2, Bob has continued to scrub through participants at the venue, and also selected participant 1209 “Jess” to park her tile on his view. He already pressed the like button for Katy, so it shows darker (or red) but not Jess, whose heart remains outlined. For events with participants representing professional groups, their business names and titles may be displayed alongside their participant seat numbers, which are usually anonymous seat numbers assigned to participants for an event, to prevent participants from later being stalked by other participants.

Just as at a physical event with tens of thousands of participants to choose from, participants will pay attention to a small subset of them at a time. Scrubbing through the strip quickly pops up participant video feed avatars one at a time, so just like a focused scanning around a large crowd for interesting people, the mood of a whole venue can quickly be sampled. Combining social media tools such as tagging people with ‘likes’ and searching for most ‘liked’ or by ‘those who like me’ or spelling of names and titles, searches can be quickly made and the results marked on the strip. In FIG. 3, the search options are in the pulldown menu (307) and results from the option ‘those who like me’ are marked by the heart icons (309) and (311). The keyboard (310) is used for entering in search queries into the search bar (306), so people can find people by the spelling of their name or title with full or partial matching.

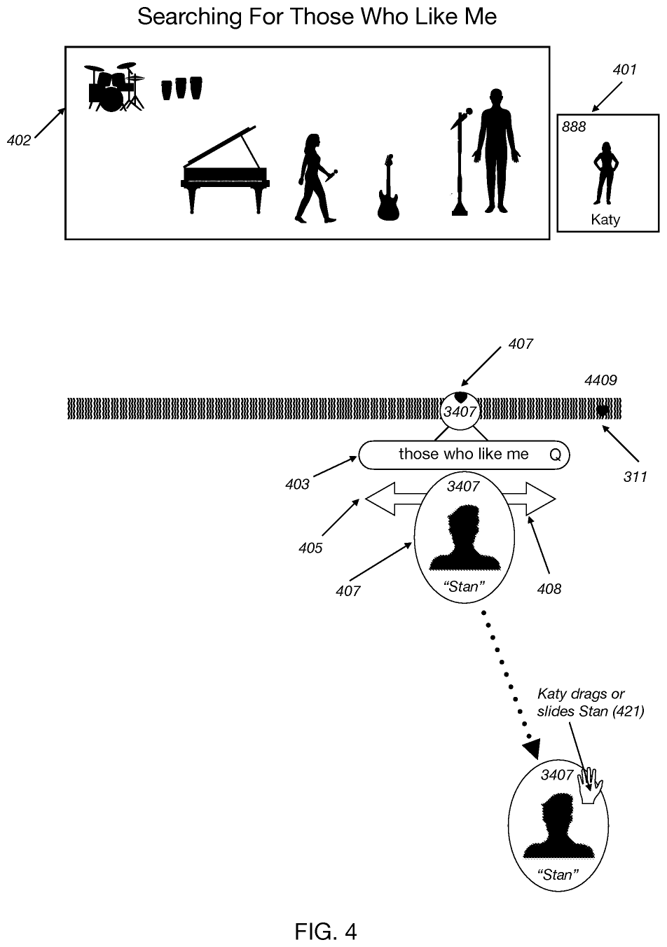

Using the ‘those who like me’ option, Katy see the participant in seat 3407 has liked her (309) and she is curious, so in FIG. 4, she clicks on the heart icon (402) and pops up a video feed from ‘Stan’. She thinks he's interesting enough to keep an eye on him. She drags the popped up view of Stan from the strip to her participant watching area (421).

After watching Stan for a while, she interested enough to want to talk to him, so she drags her avatar onto Stan's, to initiate a private conversation. In doing so, she takes a risk that he could eject her, but that's unlikely because he's already ‘liked’ her. The privacy halo (513) shows they are in a private convo, where they can hear each other, with the sound of the stage in the background. Her avatar partly covers his, indicating that she initiated this convo.

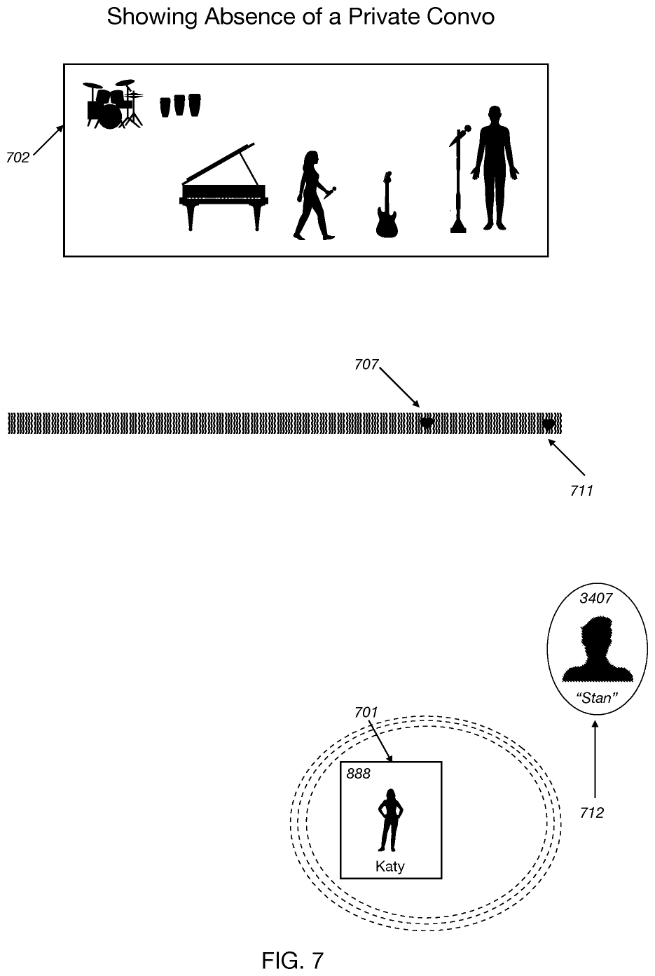

After talking to him a while, she's bored so she says goodbye and drags Stan's avatar away from her. Since she initiated this convo, Stan simply exits the convo, without being marked as ‘ejected’. In FIG. 7, the absence of any indicator linking Katy and Stan (712) shows he's simply back to the state he was in before she initiated a convo with him.

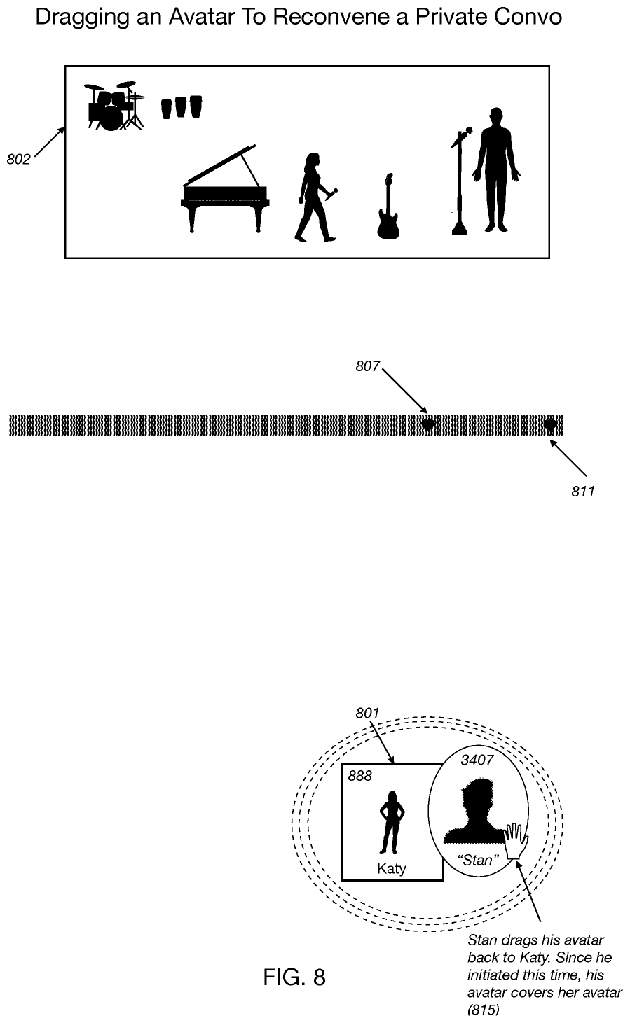

Stan however is not happy to let go just yet, so he drags his avatar back to Katy. FIG. 8 shows how his choice is viewed in Katy's user interface. His avatar partially covers hers because he initiated this convo (815). By initiating this convo, he's taking a risk that she will eject him. As it turns out, she really is not interested in continuing their convo, and asking him to leave, he does not, so she drags his avatar away from her avatar, ejecting him. The ejection indicator (905) shows as a dotted line connecting their avatars, with the arrowhead on her end pointing towards him, to show that she ejected him, and it was not him ejecting her. Many alternate forms of ejection markers may be used, for example such as sequentially blinking lines like runway lights to show the direction of ejection away from the beleaguered participant, or green lines turning red as they approach the ejection participants.

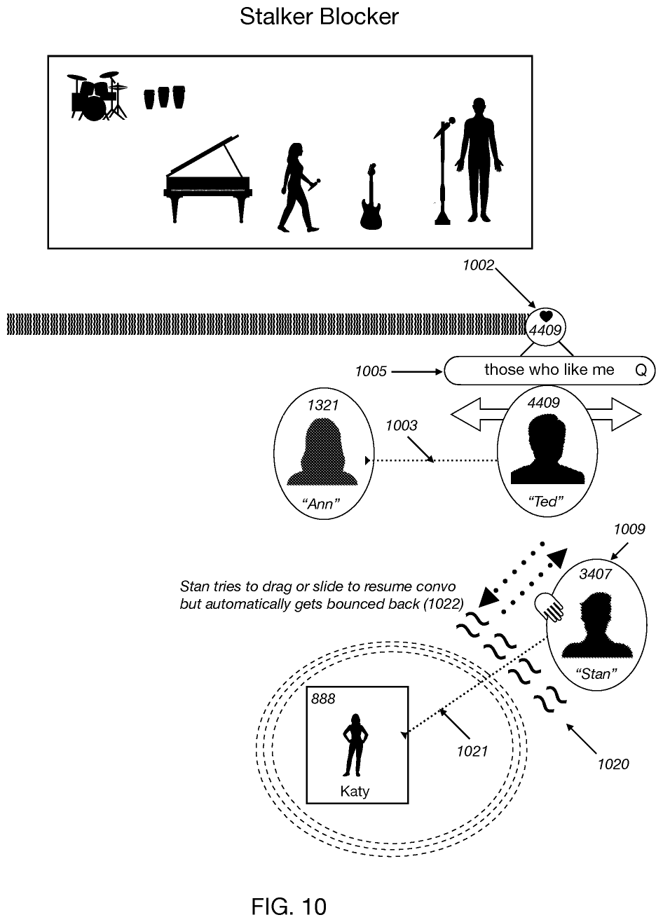

In FIG. 10 Stan is stubborn and attempts to reconvene again. The automated moderation program (FIG. 35 (4c)) engages the ‘stalker blocker’ feature to show his avatar automatically bouncing away from her avatar. In FIG. 10, Katy is already moving on from Stan to look at another participant among the ones ‘those who like me’ listed in the strip (1002). This is seat 4409 “Ted”, who pops up, with baggage in the form of an ejection line from “Ann” who previously ejected him (1003). So from this prior ejection, Katy figures Ted might also be unpleasant, and doesn't bother to pull his avatar onto her viewing area.

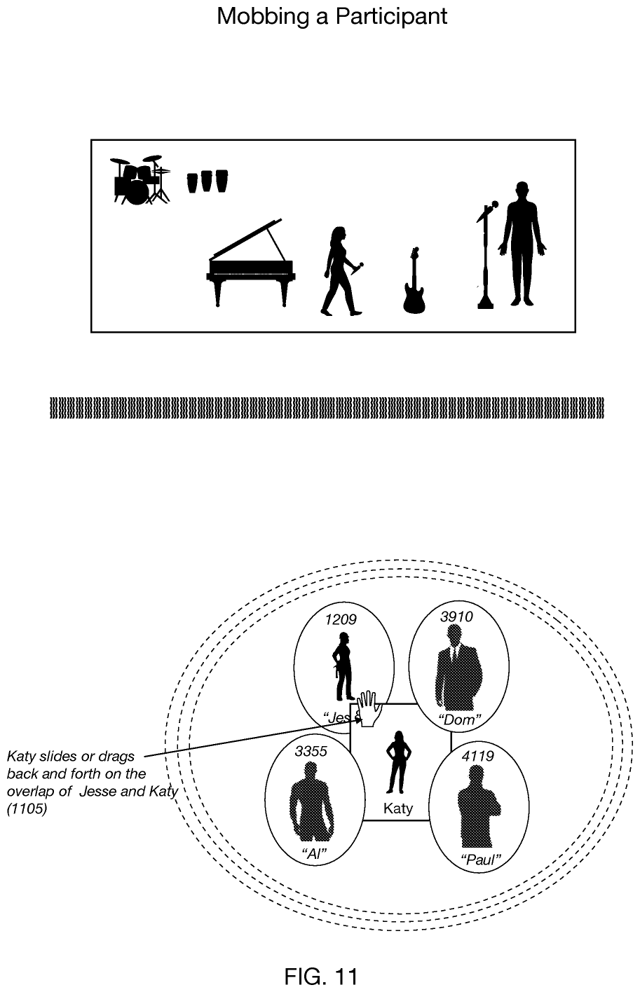

In cases of people ganging up on other people, it's possible that dragging one avatar at a time is not quick enough to handle all the incoming unwanted participants barging in on your avatar. The present invention grants another ‘super power’ to handle even extreme versions of ganging up. By dragging back and forth on the overlap between you and someone you want to maintain conversation with avatar, you free yourself from the others, who are ejected if they initiated the overlap or just exit if you initiated their overlap with your avatar. In FIG. 11 Katy puts her cursor down on the overlap between her and Jess, to keep Jess in the convo and by dragging that selection back and forth (1105), ejects the others from the convo.

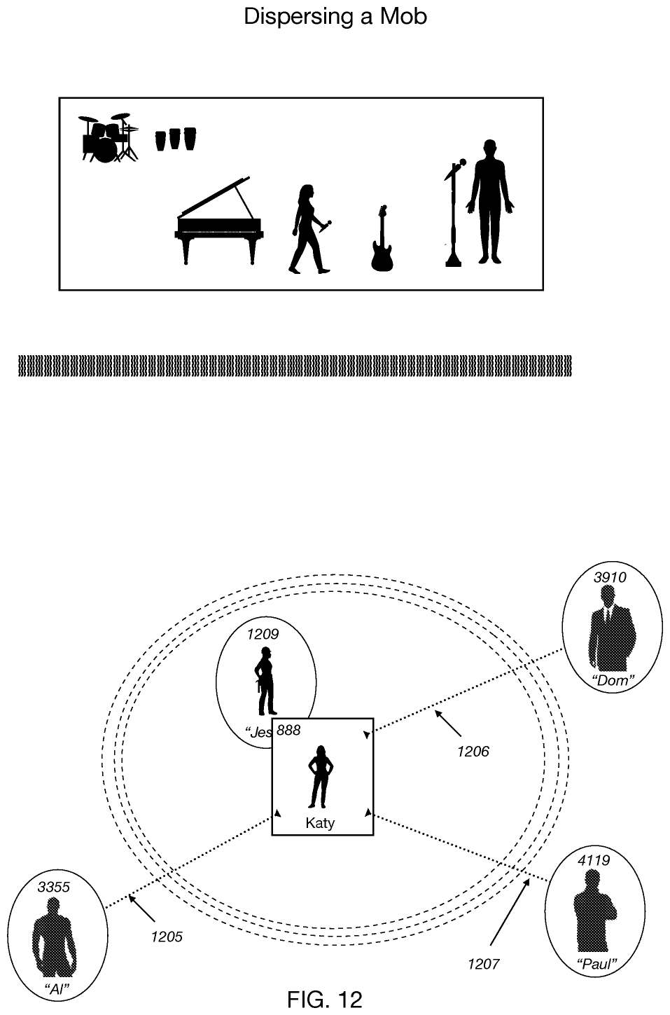

FIG. 12 shows the results of that ejection. Ejection lines (1205), (1206), and (1207) with arrowheads pointing away from Katy show that she ejected Al, Dom and Paul. Jess remains in the private conversation with Katy, so they can talk about why she ejected the others.

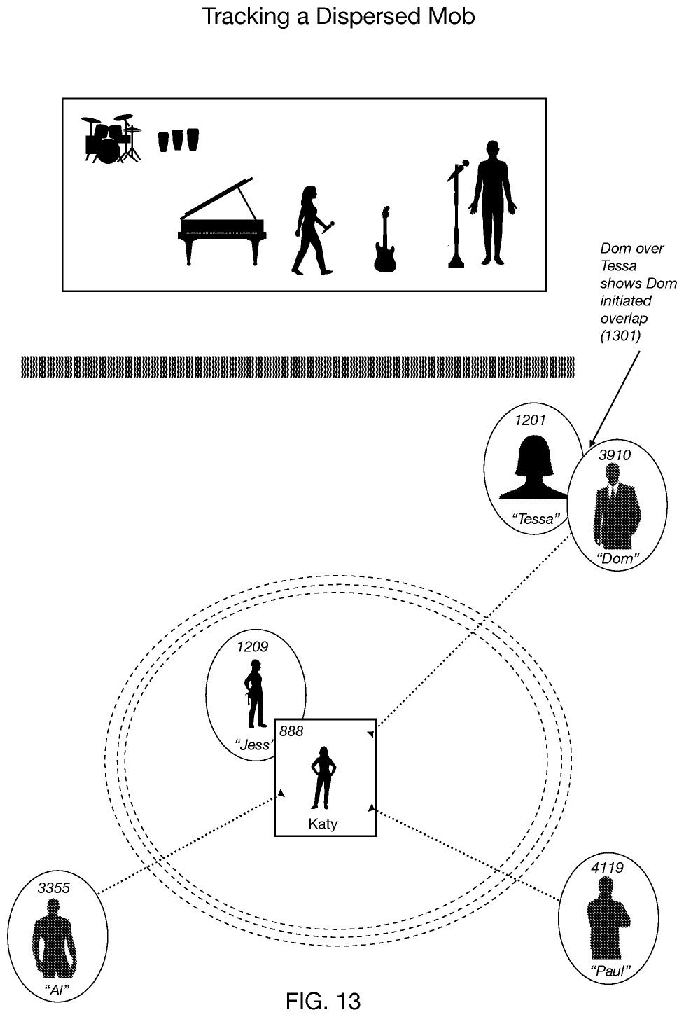

In FIG. 13, Katy can use her view to see what other participants are doing with the ejected participants. She sees that Dom has initiated a convo with Tessa, and Katy wants to warn her about Dom. So Katy initiates a convo with Tessa, but only from the side so as to exclude Dom from what she says to Tessa. Jess remains in a convo with Katy, but cannot hear what Tessa says, because Jess' tile doesn't overlay with Tessa's tile.

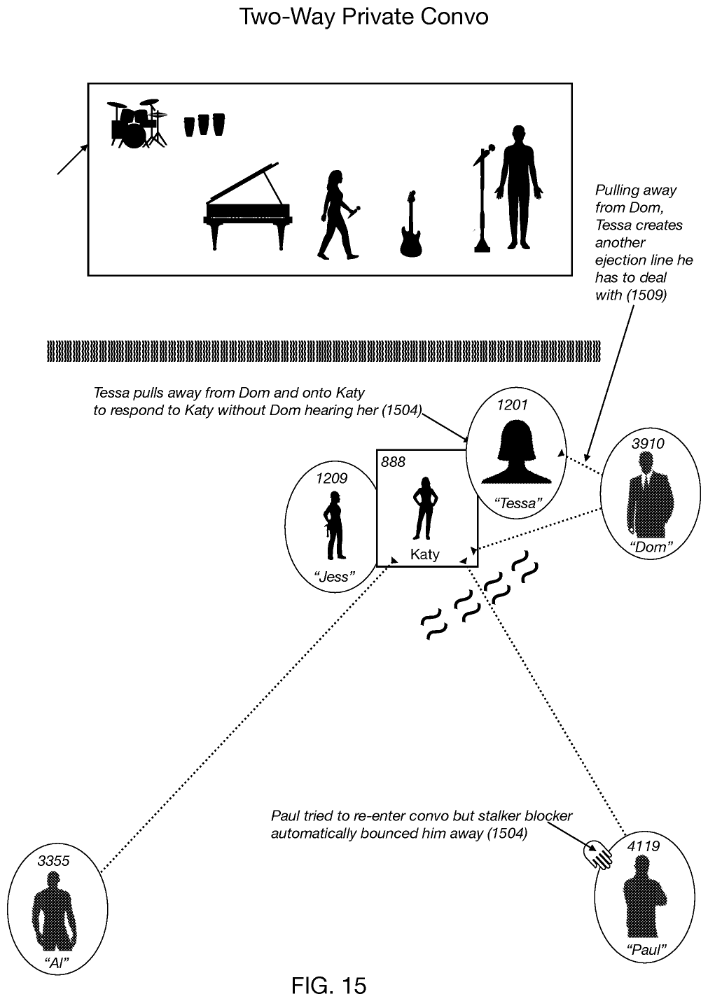

Tessa is intrigued by what Katy tells her about being mobbed by Dom and others. Tessa can see that from ejection lines radiating from Katy that there was a mass ejection. In FIG. 15, Tessa become more interested in talking to Katy than Dom, so she pulls away from Dom, creating another ejection indicator (1509) for Dom.

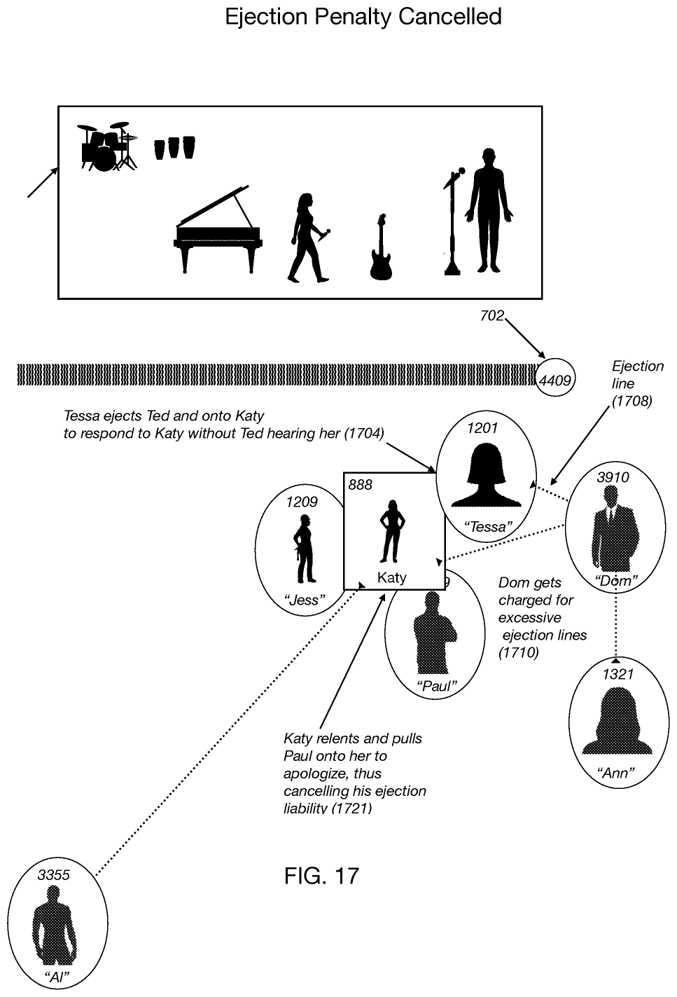

Meanwhile Paul has tried to reconvene with Katy, but gets bounced away by the stalker blocker. But Tessa can see this and tells Katy she knows Paul to be impulsive and actually a nice guy (1604). So Katy relents and pulls Paul back into her private area to apologize to him for ejecting him. In FIG. 17, initiating this pullback automatically cancels the ejection mark associated with Paul (1721): he no longer risks going over the penalty limit for ejection marks (or lines). Dom, on the other hand, has barged into Ann's private area and after not liking that, she ejected him. So Dom now has three simultaneous ejection marks, putting him over a preset ejection limit and causing him to have a penalty. In this case, a reasonable penalty would be to forfeit a cash deposit he pays to attend the event, which is normally refunded for good behavior. A more stringent penalty would be to isolate him from all others at this event: no more private conversations. A most stringent penalty would be to eject him from the entire event. The choice of penalties and their triggering levels are best setup as default which can be adjusted by event hosts, depending on what mood in the event is desired. A more raucous event could have higher triggering limits for penalties.

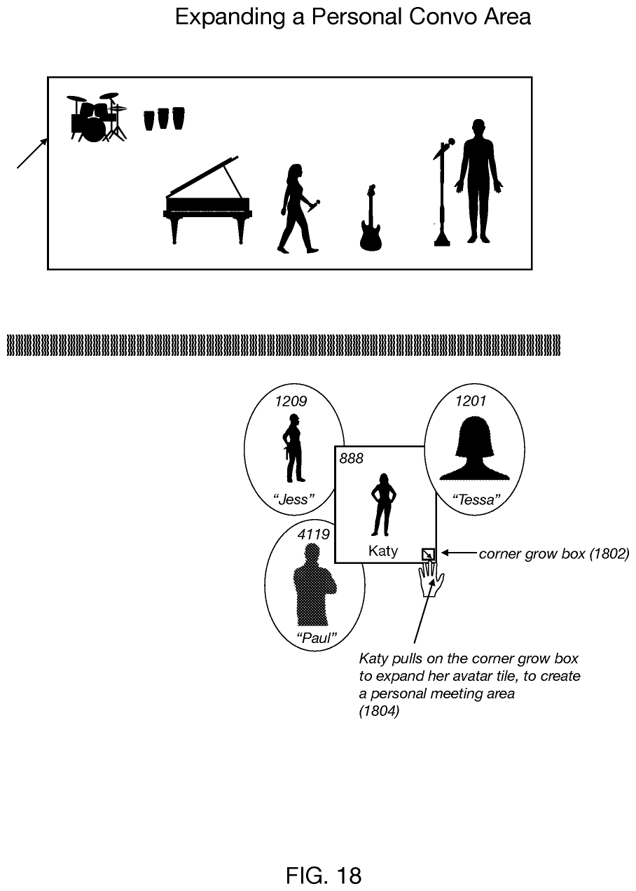

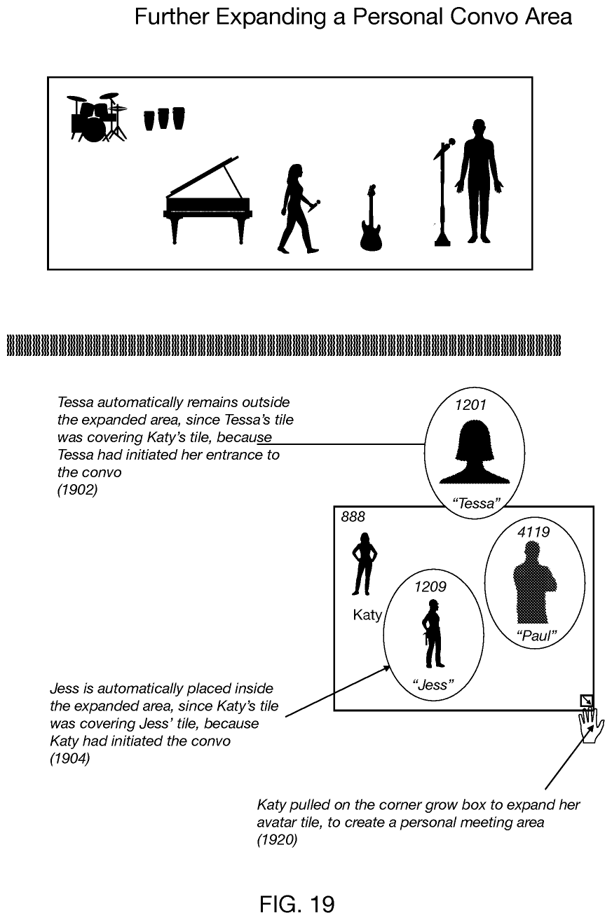

There is now some congestion in Katy's personal area. Now that she has four participants in her personal area, she might need more space to arrange which ones are overlapping under her and which are overlapping covering her, and which ones overlap with each other. FIG. 18 shows how she can pull on a corner sizing icon (1802) to expand the size of her personal area. After expanding her personal area, an automated re-arrangement of the avatars show in FIG. 19.

Tessa, who had initiated participating on this convo, is perched on the outer rim of Katy's expanded area (1902). She can hear and speak to Jess (1904) and Paul who are on the inside. Now although Jess and Paul could not hear each other before, they can now because they are inside a private meeting area. So by expanding into a personal meeting area, Katy makes it easier for a larger number of participants to all talk to each other without the difficulty of arranging an overlap between all their tiles.

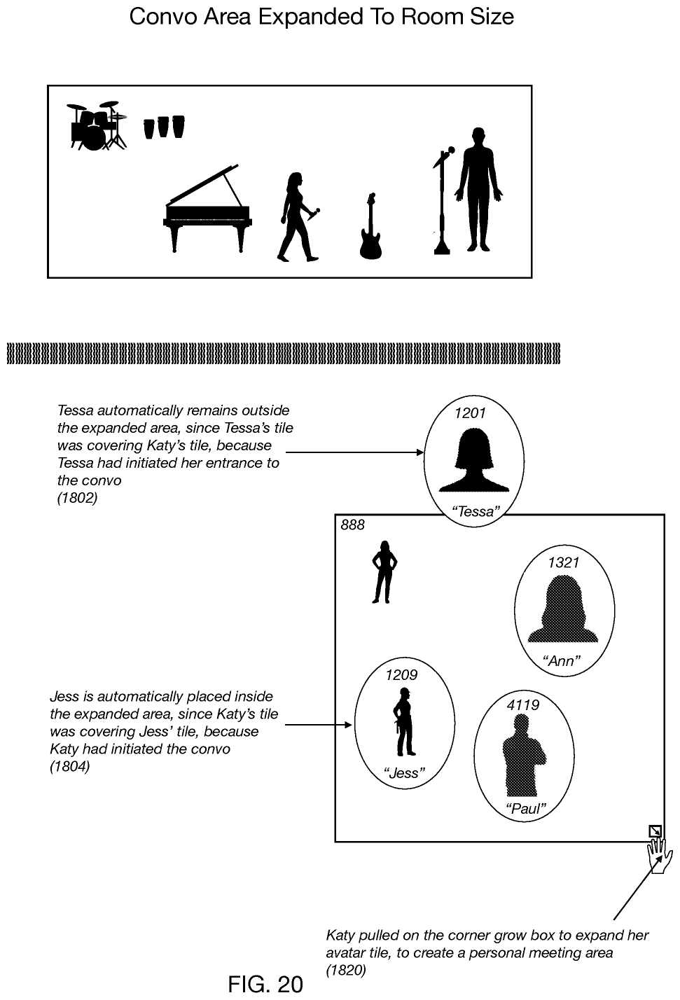

With an even larger personal convo area, Katy can manage it as a personal breakout room. In FIG. 20, she's pulled in Ann to talk to Jess and Paul. Now should any of the participants inside Katy's personal breakout room perform a mass ejection, the question of who exits and who get ejected is determined by who initiated to get into the convo. If Jess, for instance, dragged her avatar back and forth, the other inside participants Ann and Paul would simply exit from Jess and the conversations, but Katy would get an ejection marker from Jess for initiating bringing Jess in, and Tessa would get ejected since Tessa initiated coming in (ejection not shown).

If any of the the ejected participants tried to come back, the Stalker blocker would bounce them off. If any of the exited participants tried to come back, they would appear on the rim, and from there have a higher risk of ejection.

In FIG. 20 Katy has further expanded her personal meeting area to allow her to pull in Ann to the private conversation. There could be room in Katy's user interface to manage a private meeting area as large as a dozen avatars, and whenever someone scrubs through to view her they will see the whole meeting room she has setup. On the basis of who else they see in meeting, this might interest them.

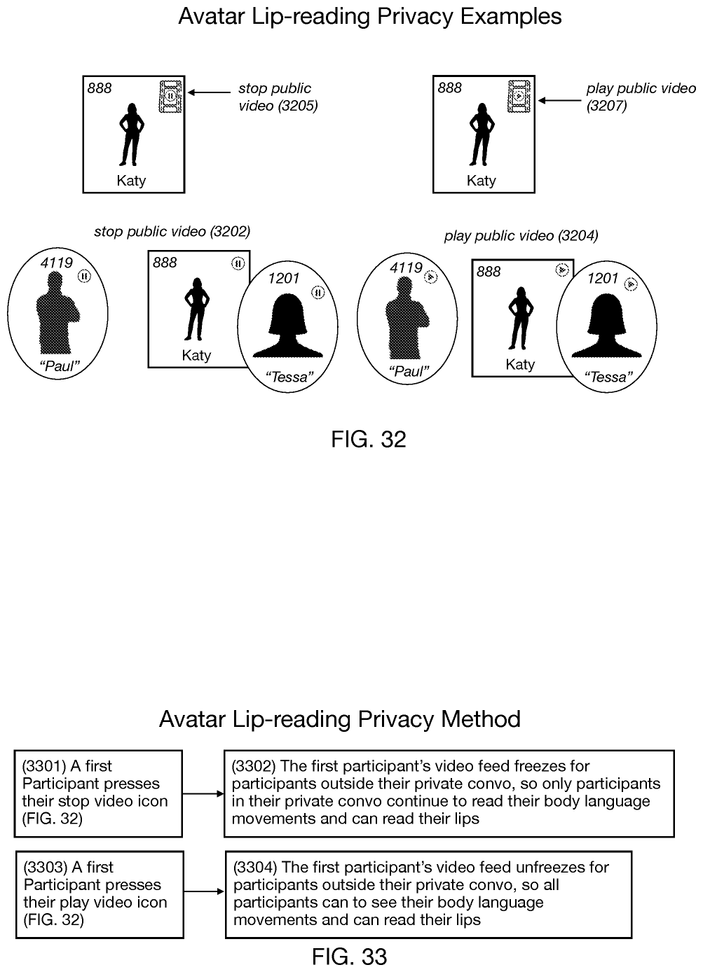

There is an issue of privacy affecting by how secretly participants may wish to meet. In examples given above, audio privacy is assured, but video movement privacy not so much. For some cases, visual privacy in private conversations is needed, so FIG. 32 shows examples of icons that are setup so participants can control who can see their movements. This protects them from lip-readers and people who would interpret their body language while they are discussing personal private topics.

The motion privacy icons look like the stop-start controls of movie playing apps. Pressing the stop icon freezes the video feed seen by participants outside the private conversation, showing them a frame grab from at or a little before they pressed the button, but allows participants inside the convo to see the video feed unimpeded. Pressing the start button which appears in the place of the stop button resumes the showing of unimpeded video to all participants. At the top of FIG. 32, an ornate icon to freeze public video is shown (3205) and a similar ornate icon to unfreeze public video is shown (3207).

At the bottom of FIG. 32, simpler privacy control icons to freeze (stop) public video are shown (3202). If Paul were to press his, since he is not in a private meeting, other participants would only see his freeze-frame. If Katy were to press hers, only Tessa who she is in a private convo with would see her motion video, and all other participants would only see a freeze frame. This would be appropriate if they were discussing something very private, for instance, their comments about Paul. If Tessa were to also press her freeze frame button, only Katy would see her motion, and others would only see her avatar as a freeze-frame.

When their need for motion privacy has passed, they can press their unfreeze (play) buttons which appear in place of freeze buttons when the freeze buttons are pressed, shown as (3204). Motion video is much more interesting to watch than freeze frames, so participants largely will choose to display their motion video, in order to attract people to talk them.

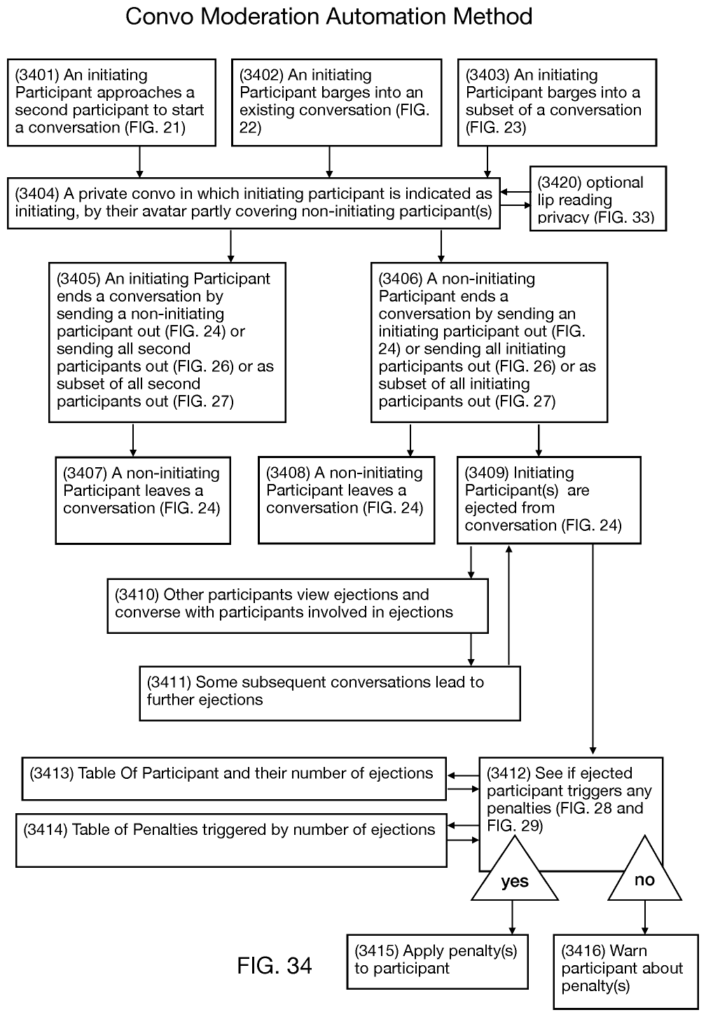

Method diagrams in the Privacy Method of FIG. 33 clarity the computations for supporting the button in FIG. 32. The action detected in (3301) leads to the result in (3302). The action detected in (3303) leads to the result in (3304).

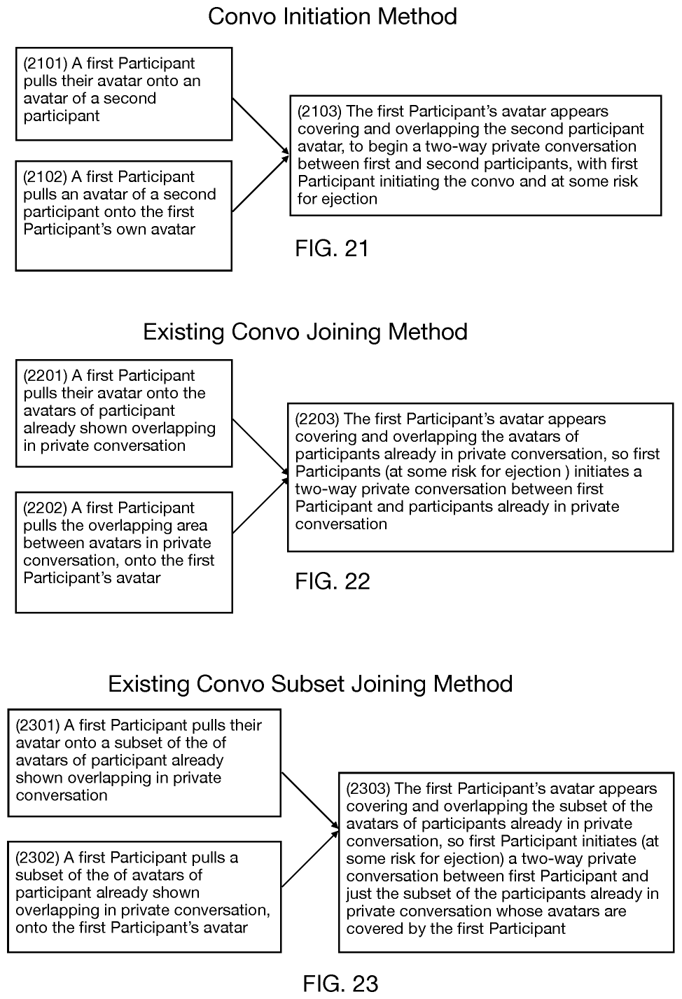

In method diagrams of FIGS. 21 to 31, and FIG. 34, similar notation is shown, with the addition of branching tests ‘yes’ and ‘no’ marked by triangles appending to the edge of rectangles where branching logic is used.

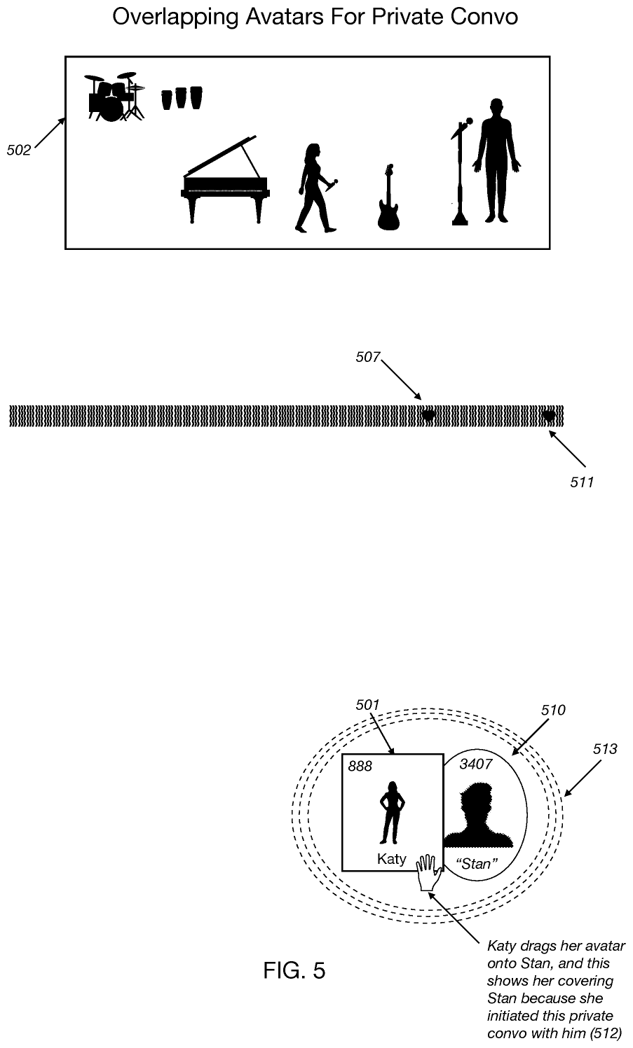

For a Convo Initiation Method, FIG. 21 shows two method steps converging on a single result. In (2101) a first Participant pulling or dragging their own avatar onto a second one leads to (2103) where both are in a private convo with first participant at some risk of ejection. An example of this is shown in FIG. 5. In (2102) a first Participant instead pulls or drags on a second participant to start a convo and this also leads to the same result (2103).

For an Existing Convo Joining Method, FIG. 22 shows a similar convergence of steps (2201) and (2202) results in the single result (2203). FIG. 22's method differs from FIG. 21 since the Participant in FIG. 22 is barging in an existing conversation, whereas in FIG. 21 the Participant is creating a new convo.

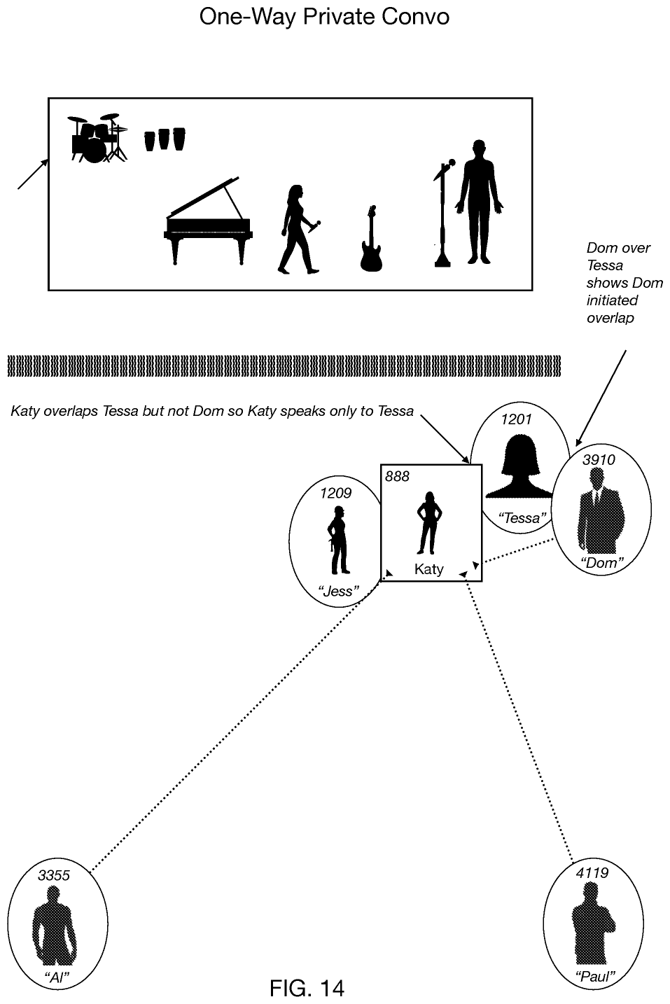

For an Existing Subset Joining Method, FIG. 23 shows a similar convergence of steps (2301) and (2302) results in the single result (2303). FIG. 23's method differs from FIG. 22 since the Participant in FIG. 23 is barging in on just some of the participants in an existing conversation (an example of this is Katy in FIG. 14), whereas in FIG. 22 the Participant is barging in on all of them.

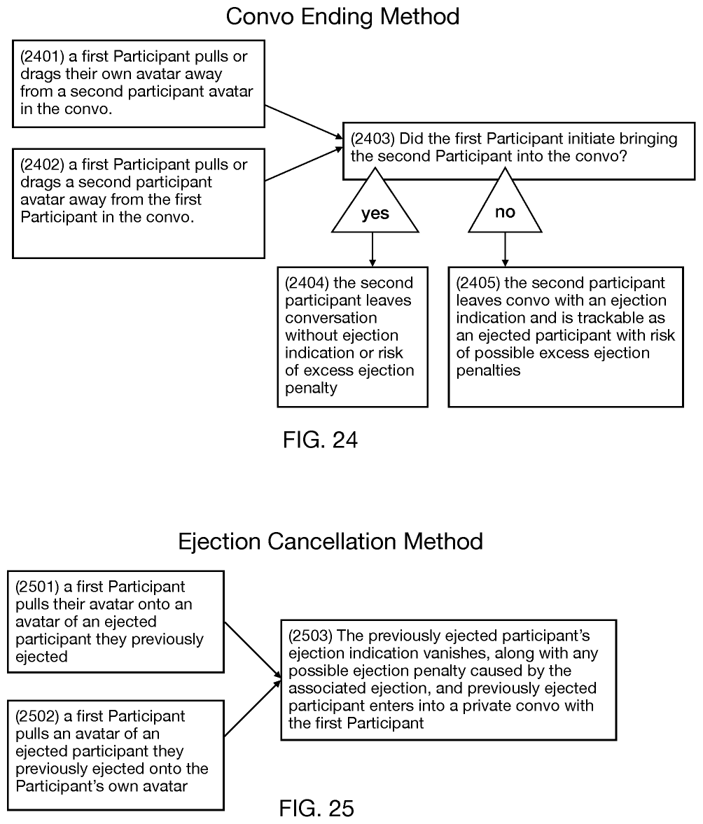

For a Convo Ending Method, FIG. 24 shows a convergence of two steps (2401) and (2402) into a single intermediary logic branch (2403). (2401) and (2402) differ in that the former (2401) has the first Participant puling on their own avatar, and in (2402) the first Participant pulls on the second participant's avatar. Both actions lead to a common logic branch (2403) which determines whether the first or second participant initiated the convo between them. For the first Participant initiating, the result is (2404) where the second participant simply exits without ejection. (An example of this is shown in FIG. 7 with Stan's exit.)

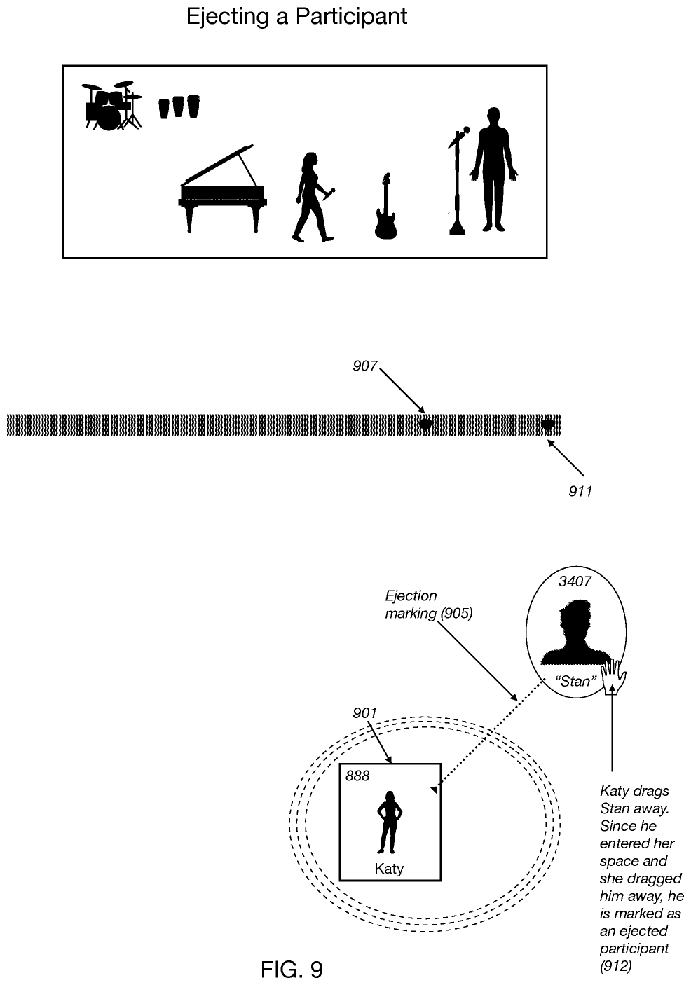

For the second participant initiating, the second participant has more responsibility and therefore is ejected (2405). (An example of (2405) in shown in FIG. 9 with Stan's ejection.)

For an Ejection Cancellation Method, FIG. 25 shows a convergence between two actions (2501) and (2502) which both lead to a single result (2503). (2501) and (2502) differ in that in the former the first Participant moves their own avatar, and in the latter moves their second participant's avatar. (An example of (2502) is shown in FIG. 17 with Paul.)

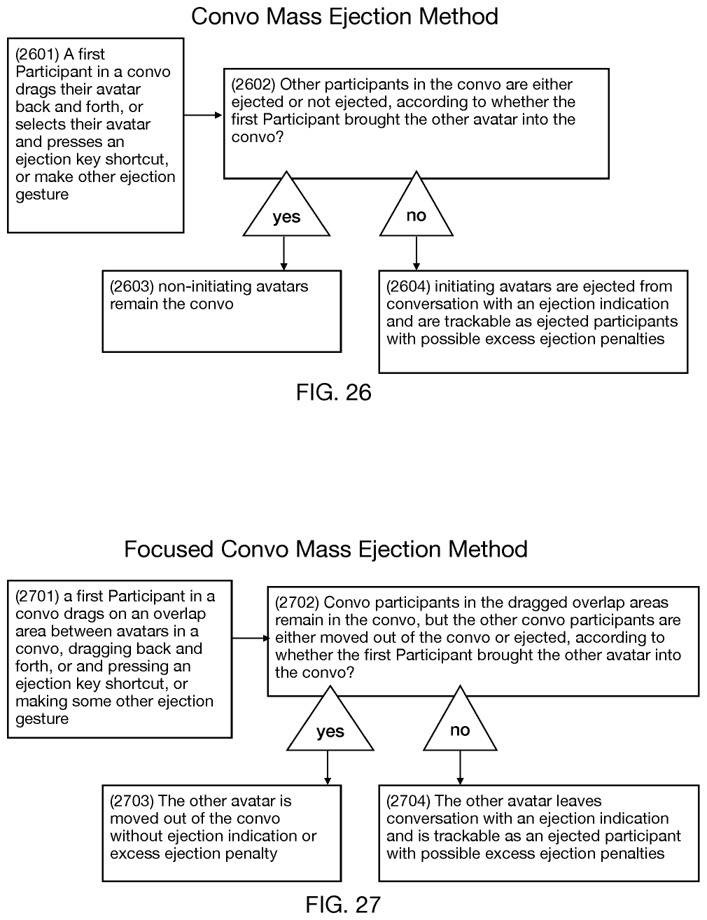

For a Convo Mass Ejection Method, FIG. 26 shows an action (2601) which leads to a branch logic (2602) where participants which did not initiate their entry into the convo remain in the convo (2603), and participants which did initiate are ejected (2604).

For a Focused Convo Mass Ejection Method, FIG. 27 shows an action (2701) which leads to a branch logic (2702) where participants in the dragged overlap area remain in the conversation, and other participants in the convo are either ejected if their initiated their entry into the convo (2704) or simply exit the convo if not (2703). (An example of (2704) is shown in FIG. 11 by Al, Paul and Dom. In the overlap area are Jess and Katy who remain in the conversation.)

For an Ejection Tracking Method, FIG. 28 shows ways participants can view the aftermath of an ejection, particularly for mass ejections, to see behavior patterns which help them to decide how they would like to be involved. Starting with the ejection event (2801) leading to the initial aftermath display (2802), some first participants may want to quickly move on and forget about the ejected participants. (2803) gives them the option to drag the ejected participants off of their view (2804). Other participants viewing the ejected participants will however still see the ejection lines linking them to the first participant and know that there is trouble there. Each interaction between the ejected participant and further participants is mapped against that ejection. When the ejected participant enters in a convo with a third participant, others may intervene to warn the third participant about the ejected participant (2806). (An example of (2806) is shown in FIG. 17 with Katy and Tessa.)

When an ejected participant causes further distress and is ejected another time, this second ejection is visibly paired with first, drawing more attention to the ejected participant (2805). (An example of this is shown in FIG. 17 with Dom.)

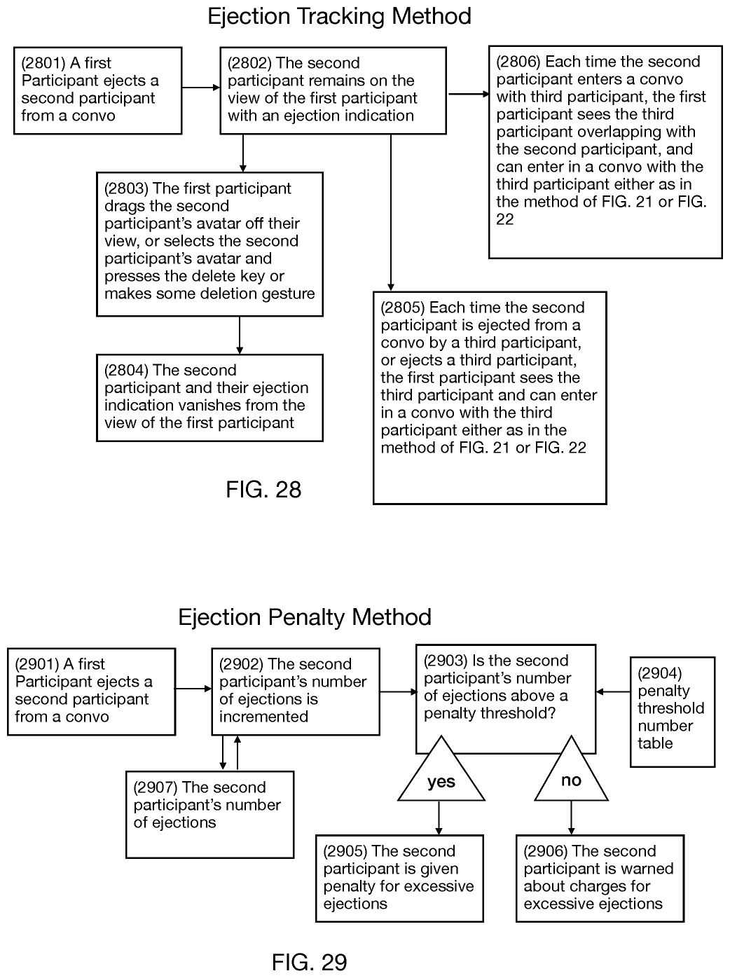

For an Ejection Penalty Method, FIG. 29 shows a starting ejection event (2901) leads to the number of ejections for the ejected participant being looked up in (2907) and incremented (2902). Then, the new higher number of ejections is compared (2903) to all defined penalties and corresponding threshold numbers in a table of penalty types linked to threshold numbers (2904). If any penalties thresholds are met, the ejected participant is given corresponding penalty (2905), and if not, they are warned about the closest penalty to their number of ejections (2906). Examples of penalty types and corresponding numbers could include ‘forfeiture of the their good behavior deposit’ at three ejections, ‘temporary 20 minute isolation from private conversations’ at four ejections, ‘ejection from the entire event’ at five ejections. (In FIG. 17 Dom would therefore forfeit his deposit and get a warning about being isolated from private conversations at his next ejection.)

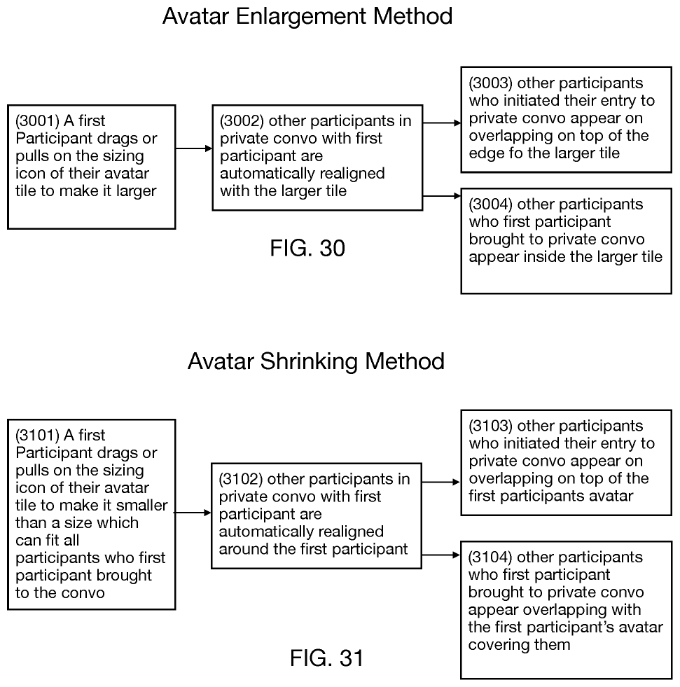

For an Avatar Enlargement Method, FIG. 30 shows how to automatically transform a participant's standard avatar tile into a private meeting area. Starting with a first participant choosing to drag on the sizing icon (or grow box) in the avatar tile (3001) whatever participants already in conversation with the first participant are automatically rearranged in the new larger framework. This allows easier future arrangement of private conversations among all participants overlapping with the first participant. Rather than having to overlap each combination of participants to fully share in conversation, any of the participants can speak to and hear every other participant in the larger framework (3002). Overlapping participants which initiated their entry to the convo are shown at the edge of the framework (3003). Overlapping participants which were brought into the convo by the first Participant are shown inside the framework (3004). (An example of this is shown in FIGS. 18 and 19. In FIG. 19 Tessa is automatically rearranged to appear on the edge of the framework (1901) and Jess is automatically rearranged to appear inside the framework (1904).

Going forward from the rearrangement, the same distinctions between participants who initiated their entry to the convo and those who did not, in terms of ejections risks, are the same as before the rearrangement, since their indications about whether their initiated entry remain consistent, though displayed slightly more obviously.

For an Avatar Shrinking Method, FIG. 31 shows steps to takes a first participant's private meeting area and shrinks it down to a default avatar tile, reversing the steps of FIG. 30, and preserving the the same distinctions between participants who initiated the entry to the convo and those who did not, in terms of ejections risks.

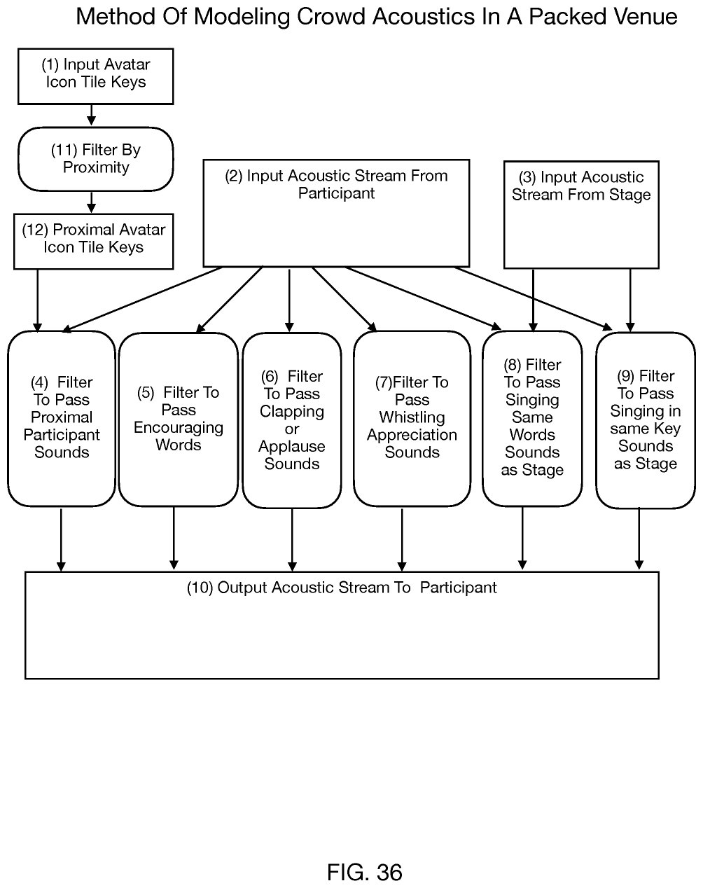

To enliven performances, the present invention has methods to model crowd acoustics, primarily by focusing on the positive audio feedback that individual participants may give to performers in the method of FIG. 36. In this simulation method, filters passing only positive feedback such as clapping, whistling and encouraging words merge this approved output streamed to all participants. For audience participation sounds, which also enliven performances, other filters using speech recognition can pass along words sung matching the words sung on stage from (3) Input Stream from Stage. And for additional audience participation sounds, (9) Filter passes along singing detected as singing in the same key as Sound from Stage. Together, these higher quality audience participants sounds can boost the level of excitement felt from a performance, and as a practical matter, reduce the spurious sounds occurring in a prior art venue which may interfere with or degrade the clarity of sound from the performers on stage.

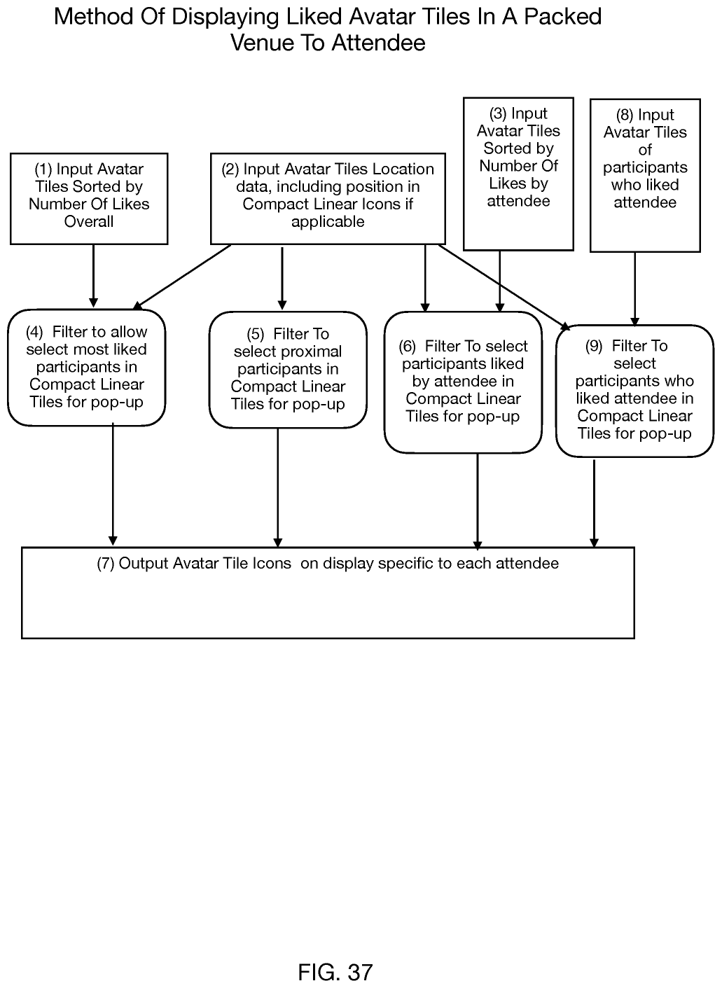

To provide easy-to-use search options in the search bar of FIG. 3, the Method Of Displaying Liked Avatar Tiles in FIG. 37 calculates the search results to be shown in the strip of FIG. 3, shown a heart icons at (309) and (311). In the method of FIG. 37, the strip of FIG. 3 is referred to as ‘Compact Linear Tiles for popup’.

To show an overview of methods taught by the present invention, the Convo Automation Moderation Method of FIG. 34 shows how various methods presented in FIGS. 21 to 31 are integrated into a way to shift behavior of participants toward more production interactions. Steps (3401), (3402), (3403) and (3404) collect the data which distinguishes between participants who initiated their entry into convos and those who did not. Later steps (3405), (3406), (3407), (3408), and (3409) determine whether participants exit convos on good terms or are ejected, based on the earlier data collection steps.

Since each ejection event is evidence of interaction flaws, these flaws are addressed at several levels:

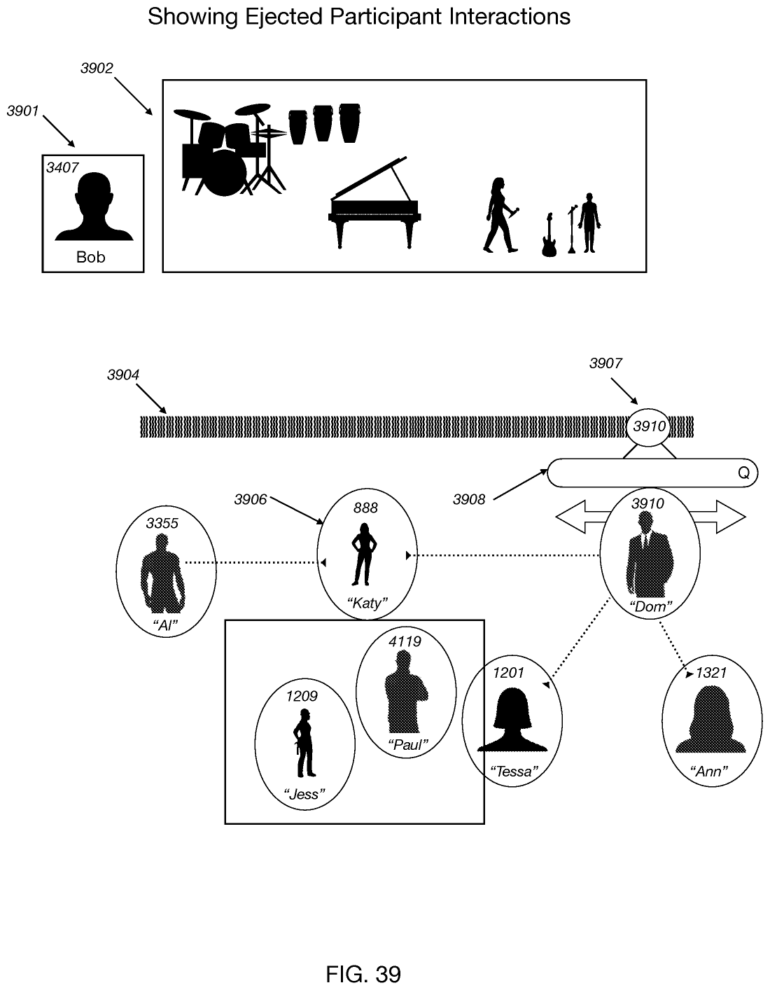

To discourage people from behaving in ways that get them ejected, steps (3410) and (3411) give the community of participants chances to alter perceptions of the people involved in ejections, by publicly displaying ejection lines linking affected participants, so people can enter into conversations with them. FIG. 39 shows how the Dom with 3 ejections looks when people pop him up from the strip (3907).

To further discourage people from behaviors that get them ejected, steps (3412), (3415) and (3416) warn and apply penalties to multiple-ejected participants, as in FIG. 29.

The present invention thus solves the scalability of problem of host moderation for large events: where virtual event venues traditionally become toxic because it is not cost-effective to moderate all participant-to-participant interactions, virtual venues constructed according to teaching of the present invention can host thousands or tens of thousands of participants since the crowd control and security controls are in the hands of super-power enabled participants themselves. As long as the willingness to face down transgressors remains, those with courage to simply eject transgressors provides all the evidence necessary for the present invention to automatically close the loop on transgressors by publicizing shaming them with ejection lines and assessing them for penalties. FIG. 39 shows how Dom would appear in Bob (3901) as he scans participants, after Dom has been ejected three times. Here, Bob can not only see Dom's three ejections from Ann, Katy and Tessa, but also that Katy has ejected Al and started her own private meeting area with Jess, Paul and Tessa. This kind of view provides the kind of interesting personal interactions people see are at large physical venues: small groups of people who are made more meaningful by the character of their groupings.

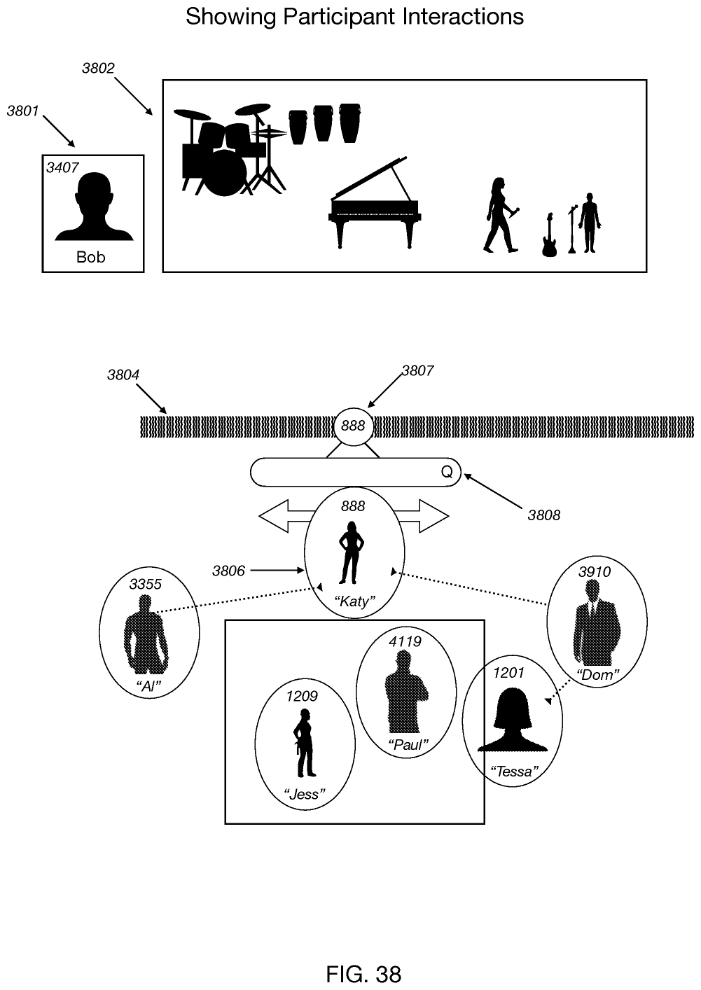

For contrast, the more popular Katy in FIG. 38 is seen by Bob (3801) to have ejected two people: Al and Dom. She has opened up her own private meeting area with Jess, Paul and Tessa. Tessa has also ejected Dom, which is probably something they are talking about in the private meeting area. All of this shows Katy in a much more positive light than Dom. And unlike the view Bob earlier saw of Katy in FIG. 1, this view of Katy in FIG. 38 is much more interesting.

Especially for meetings among strangers, clues from such ejection patterns can reveal hidden mitigating factors leading people to give others second chances, particularly when ejectors themselves are ejected, or ejected become ejectors. In these cases, outside observers may step in knowing they can make a difference, since the circumstances of ejections are often worth talking about.

I claim:

1. A computer-implemented user interface method adjusting the acoustic transmissions between videoconference participants, distributing the control of these adjustments to individual participants to increase venue scalability by reducing host intervention labor, wherein a first participant may choose to drag their avatar tile to overlap another participant avatar tile to automatically create a private acoustic zone of conversation around both participants, and wherein a second participant in the private acoustic zone of conversation may optionally subsequently choose to drag the first participant tile away from the private acoustic zone of conversation to automatically eject the first participant from the private acoustic zone of conversation.

2. The method of claim 1 wherein the ejected first participant may subsequently choose to drag their own avatar onto the second participant avatar again, which automatically causes a bouncing of the ejected first participant back to their prior position outside the private acoustic zone of conversation, thus automatically preventing ejected first participant from re-entering the private acoustic zone of conversation of the second participant.

3. The method of claim 1 wherein the second participant may choose to drag the avatar of the ejected first participant back onto the second participant avatar to automatically cancel the prior ejection of the ejected first participant from the private acoustic zone of conversation, and to automatically reinstate the ejected first participant in the private zone of conversation.

4. The method of claim 1 wherein an acoustic zone of privacy containing a first participant has a multiplicity of second participants whose avatar tiles do not overlap with other second participant avatar tiles, and using a non-commutative privacy calculation, automatically second participants cannot hear or talk to other second participants, but first participant can hear and talk to each of the second participants.

5. The method of claim 1 wherein acoustic transmissions between videoconference participants are filtered for positive audience feedback or audience participation sounds to be transmitted to all participants, including participants who would otherwise not hear these sounds.

6. The method of claim 1 wherein a multiplicity of videoconference participant avatar tiles are reduced in size and detail and placed adjacent to each other to squeeze more tiles into the user interface, so participants can scan through a larger multiplicity of avatar tiles, to display a popped out subset of them at full size by moving a cursor or pointing device along the multiplicity of reduced size tiles.

7. The method of claim 6 wherein full sized versions of reduced size tiles can be popped out and dragged away from selected reduced size tiles, to keep selected participant tiles displayed as full size versions.

8. The method of claim 26 wherein participants can click on buttons to indicate they have interest in other specific participants, and this indication of specific interest is displayed to the participants they are interested in, either by showing the interested participant's name or other personal identifiers.

9. The method of claim 1 wherein activation of a private zone of conversation is indicated as a halo around avatar tiles of the participants which are in the private acoustic zone of conversation.

10. The method of claim 1 wherein a dragging on the tile overlap areas of a private acoustic zone of conversation drags both of the tiles of the overlap area in unison.

11. The method of claim 1 wherein instead of dragging an avatar the onto another avatar tile to activate a private acoustic zone of conversation, the participant just drags an avatar tile up to another avatar tile to activate a private acoustic zone of conversation

12. The method of claim 1 wherein a first participant is ejected from a conversation where first participant who initiated a private conversation and was subsequently removed from that conversation by a second participant, causing a display of ejection markers from second participant's avatar and directed at first participant's avatar.

13. The method of claim 12 wherein a first participant ejected from a conversation accumulates a total number of ejections which are compared to a table of penalties corresponding to triggering levels of ejections, and a first participant triggering a penalty is automatically given the penalty.

14. The method of claim 12 wherein a first participant ejected from a conversation accumulates a total number of ejections which are compared to a table of penalties corresponding to triggering levels of ejections, and a first participant is warned about the penalty whose triggering ejection number is closest to their total number of ejections.

15. The method of claim 1 wherein a first Participant in a private conversation may drag their avatar back and forth, or select their avatar and press an ejection key shortcut, or make other ejection gestures, causing other participants in the convo who initiated their entry into the private conversation to be automatically ejected from the conversation.

16. The method of claim 6 wherein the display of tiles at full size also includes for each display of a tile at full size, also showing other avatars connected to the display tile via private conversations or personal conversation areas, or ejections markers.

17. The method of claim 1 wherein the videoconference video feed from a first participant is stopped at a freeze frame when the first participant selects a freeze option, and the videoconference video feed from a first participant continues unfrozen when the first participant selects a an unfreeze or play option.

18. The method of claim 17 wherein the videoconference video feed from a first participant continues to be seen by any second participant in a private conversation or private meeting area with the first participant, regardless of whether first participant has selected a freeze option.

19. The method of claim 1 wherein the videoconference video feed from a first participant expands their default avatar tile into a private meeting area by dragging or pulling on a sizing icon.

20. The method of claim 1 wherein the videoconference video feed from a first participant shrinks their private meeting area into a default sized avatar tile into by dragging or pulling on a sizing icon.
